(19) United States
(12) Patent Application Publication
(10) Pub. No.: US 2026/0302620 A1
(43) Pub. Date: Oct. 1, 2026

(54) LOW-POWER-MODE ANTENNA TUNING

(71) Applicant: QUALCOMM Incorporated, San Diego, CA (US)

(72) Inventors: Yahia RAMADAN, San Jose, CA (US); Kamalakar GANTI, San Marcos, CA (US); Thawatt GOPAL, San Diego, CA (US); David Loweth WINSLOW, San Diego, CA (US)

(21) Appl. No.: 19/095,247

(22) Filed: Mar. 31, 2025

(51) Int. Cl. H01Q 5/335; H04W 52/02

(52) U.S. Cl. CPC H01Q 5/335; H04W 52/0232; H04W 52/028

(57) ABSTRACT

A method of antenna tuning of an apparatus that is in a low-power mode includes: obtaining operational information corresponding to at least one first radio, of a plurality of radios that includes the at least one first radio and a second radio that includes an antenna tuner controller that is asleep, the operational information comprising at least one of packet transfer level, operating channel/frequency band, traffic type, and radio ON/OFF status; waking up the antenna tuner controller, and providing an antenna matching instruction from the antenna tuner controller to at least one antenna tuner of the apparatus, based on a change in antenna tuning of the apparatus being warranted by a change in the operational information; and adjusting at least one impedance, provided by the at least one antenna tuner, based on the antenna matching instruction.

### BACKGROUND

Wireless communication devices are increasingly popular and increasingly complex. For example, mobile telecommunication devices have progressed from simple phones, to smart phones with multiple communication capabilities (e.g., multiple cellular communication protocols, WiFi®, BLUETOOTH® and other short-range communication protocols), supercomputing processors, cameras, etc. Wireless communication devices have antennas to support various functionality such as communication over a range of frequencies, reception of Global Navigation Satellite System (GNSS) signals, also called Satellite Positioning Signals (SPS signals), etc.

With several antennas disposed in a single wireless communication device, available volume for antennas is at a premium. For example, smartphones may have numerous antennas (e.g., eight antennas, 10 antennas, or more) with very limited volume due to the size of devices that consumers desire. Consequently, antenna assemblies (e.g., modules) may be limited to very small volumes, e.g., with widths of 4 mm or less.

Despite the volume restrictions for antennas, desired functionality of the antennas continues to increase. With the advent of 5^{th} generation (5G) of wireless communication technology, mmW (millimeter-wave) phased array antennas have received extensive attention to address the propagation loss and aperture blockage hurdles by introducing higher antenna gain and beamforming features. Multiple-input-multiple-output (MIMO) systems represent one of the key enablers of 5G technology to increase the spectral efficiency and system capacity by effectively streaming the transmit/receive data with two orthogonally polarized signals (cross-polarized signals) in desired directions. The trend in consumer electronics is to develop RF assemblies (radio frequency assemblies) with small form factors which can be easily accommodated within the limited space of the emerging smart devices including cell phones and tablets.

The physical requirements of antennas make maintaining or improving performance (e.g., in terms of coverage, latency, bandwidth, radiation efficiency, and/or quality of service) difficult. Further, tuning of one or more antennas while a device is in a low-power mode may be inhibited, which may lead to less-than-desirable antenna performance.

### SUMMARY

An example method of antenna tuning of an apparatus that is in a low-power mode includes: obtaining operational information corresponding to at least one first radio, of a plurality of radios that includes the at least one first radio and a second radio that includes an antenna tuner controller that is asleep, the operational information comprising at least one of packet transfer level, operating channel/frequency band, traffic type, and radio ON/OFF status; waking up the antenna tuner controller, and providing an antenna matching instruction from the antenna tuner controller to at least one antenna tuner of the apparatus, based on a change in antenna tuning of the apparatus being warranted by a change in the operational information; and adjusting at least one impedance, provided by the at least one antenna tuner, based on the antenna matching instruction.

An example wireless signaling apparatus includes: at least one antenna; a plurality of radios each corresponding to a respective radio access technology and each communicatively coupled to a respective one of the at least one antenna, the plurality of radios comprising at least one first radio, and a second radio that includes an antenna tuner controller and is configured to be asleep in a low-power mode of the wireless signaling apparatus; at least one antenna tuner communicatively coupled to the antenna tuner controller and comprising at least one antenna tuning circuit each communicatively coupled to a respective one of the at least one first radio and to one of the at least one antenna; at least one processor communicatively coupled to the plurality of radios and the at least one antenna tuner, the at least one processor configured to: obtain operational information of each of the at least one first radio, the operational information comprising at least one of packet transfer level, operating channel/frequency band, traffic type, and radio ON/OFF status; wake up the antenna tuner controller, and cause an antenna matching instruction to be sent from the antenna tuner controller to the at least one antenna tuner, based on a change in antenna tuning of the wireless signaling apparatus being warranted by a change in the operational information; and adjust at least one impedance, provided by the at least one antenna tuner, based on the antenna matching instruction.

Another wireless signaling apparatus includes: means for obtaining operational information corresponding to at least one first radio, of a plurality of radios that includes the at least one first radio and a second radio that includes an antenna tuner controller that is configured to be asleep during a low-power mode of the wireless signaling apparatus, the operational information comprising at least one of packet transfer level, operating channel/frequency band, traffic type, and radio ON/OFF status; means for waking up the antenna tuner controller, and for providing an antenna matching instruction from the antenna tuner controller to at least one antenna tuner of the wireless signaling apparatus, based on a change in antenna tuning of the wireless signaling apparatus being warranted by a change in the operational information; and means for adjusting at least one impedance, provided by the at least one antenna tuner, based on the antenna matching instruction.

An example non-transitory, processor-readable storage medium includes processor-readable instructions to cause at least one processor, to antenna tune a wireless signaling apparatus, to: obtain operational information corresponding to at least one first radio, of a plurality of radios that includes the at least one first radio and a second radio that includes an antenna tuner controller that is configured to be asleep during a low-power mode of the wireless signaling apparatus, the operational information comprising at least one of packet transfer level, operating channel/frequency band, traffic type, and radio ON/OFF status; wake up the antenna tuner controller, and provide an antenna matching instruction from the antenna tuner controller to at least one antenna tuner of the wireless signaling apparatus, based on a change in antenna tuning of the wireless signaling apparatus being warranted by a change in the operational information; and adjust at least one impedance, provided by the at least one antenna tuner, based on the antenna matching instruction.

### BRIEF DESCRIPTION OF THE DRAWINGS

FIG. 1 is a schematic diagram of a communication system.

FIG. 2 is an exploded perspective view of simplified components of a mobile device shown in FIG. 1.

FIG. 3 is a block diagram of a user equipment including one or more multi-range antennas.

FIG. 4 is a block diagram of an example of the user equipment shown in FIG. 3 including multiple antenna elements.

FIG. 5 is a block flow diagram for determining and implementing desired antenna tuning while a user equipment is in a low-power mode.

FIG. 6 is a timing diagram for synchronous radio traffic activity monitoring.

FIG. 7A is a timing diagram for asynchronous radio traffic activity monitoring.

FIG. 7B is another timing diagram for asynchronous radio traffic activity monitoring.

FIG. 8 is a state diagram of low and high radio traffic activity.

FIG. 9 is a look-up table relating radio technology, frequency/band, and radio traffic activity level of multiple radios to antenna tuning.

FIG. 10 is a state diagram of a radio traffic monitor and an antenna tuner controller.

FIG. 11 is a block flow diagram of a method of antenna tuning of an apparatus that is in a low-power mode.

### DETAILED DESCRIPTION

Techniques are discussed herein for using an antenna tuner of an apparatus that is in a low-power mode. For example, a radio traffic activity monitor may be woken up periodically or aperiodically (e.g., based on an asynchronous trigger event occurring after a threshold amount of time passing (e.g., since a most-recent monitor triggering or since an end of a most-recent triggered monitoring)). Radio traffic activity (e.g., transmit/receive packets per second) may be monitored. One or more values affecting desired antenna tuning may be assessed to determine whether a change in presently-implemented antenna tuning is desired. If a change in antenna tuning is desired, then an antenna tuner controller that is presently asleep may be woken up, and information/instruction provided to the antenna tuner controller. The antenna tuner controller may use the provided information/instruction to control one or more tuning circuits to implement the desired change in antenna tuning. These are example implementations, and other implementations may be used.

Items and/or techniques described herein may provide one or more of the following capabilities, as well as other capabilities not mentioned. Antenna tuning may be altered to improve antenna efficiency for a desired radio (e.g., based on radio performance priority, traffic type, traffic channel/band, radio traffic activity, and/or shared/non-shared antenna status, etc.). Power may be conserved for determining whether to implement a change in antenna tuning. Power may be conserved for changing antenna tuning while an apparatus is in a low-power state with a controller for changing antenna tuning being asleep. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

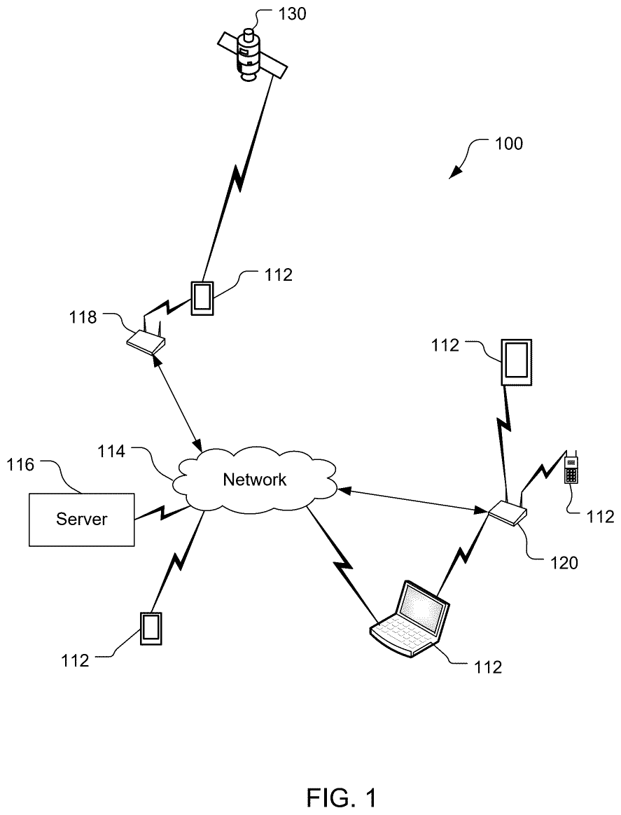

Referring to FIG. 1, a communication system 100 includes mobile devices 112, a network 114, a server 116, access points (APs) 118, 120, and a satellite 130. The communication system 100 is a wireless communication system in that components of the communication system 100 can communicate with one another (at least sometimes) using wireless connections directly or indirectly, e.g., via the network 114 and/or one or more of the access points 118, 120 (and/or one or more other devices not shown, such as one or more base transceiver stations). For indirect communications, the communications may be altered during transmission from one entity to another, e.g., to alter header information of data packets, to change format, etc. The mobile devices 112 shown are mobile wireless communication devices (although they may communicate wirelessly and via wired connections) including mobile phones (including smartphones), a laptop computer, and a tablet computer. Still other mobile devices may be used, whether currently existing or developed in the future. Further, other wireless devices (whether mobile or not) may be implemented within the communication system 100 and may communicate with each other and/or with the mobile devices 112, network 114, server 116, and/or APs 118, 120. For example, such other devices may include internet of thing (IoT) devices, medical devices, home entertainment and/or automation devices, automotive devices, etc. The mobile devices 112 or other devices may be configured to communicate in different networks and/or for different purposes (e.g., 5G, Wi-Fi communication, multiple frequencies of Wi-Fi communication, satellite communication and/or positioning, one or more types of cellular communications (e.g., GSM (Global System for Mobiles), CDMA (Code Division Multiple Access), LTE (Long-Term Evolution), etc.), Bluetooth® communication, etc.). The satellite 130 is one of multiple satellites making up one or more Satellite Positioning Systems (SPS) such as the Global Positioning System (GPS). One or more of the mobile devices 112 include appropriate components (e.g., one or more antennas) for signal transfer with other devices in the system 100, e.g., one or more antennas for receiving signals from the satellite 130 and/or one or more antennas for transmitting signals to and/or receiving signals from other ones of the mobile devices 112 and/or one or more of the Aps 118, 120.

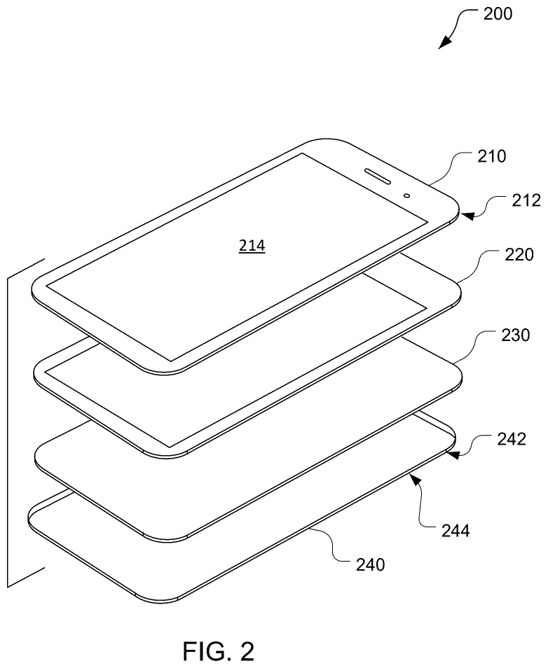

Referring to FIG. 2, a mobile device 200, which is an example of one of the mobile devices 112 shown in FIG. 1, includes a top cover 210, a display layer 220, a printed circuit board (PCB) layer 230, and a bottom cover 240. The mobile device 200 as shown may be a smartphone or a tablet computer but embodiments described herein are not limited to such devices (for example, in other implementations of concepts described herein, a device may be a router or customer premises equipment (CPE)). The top cover 210 includes a screen 214. The bottom cover 240 has a bottom surface 244. Sides 212, 242 of the top cover 210 and the bottom cover 240 provide an edge surface. The top cover 210 and the bottom cover 240 comprise a housing that retains the display layer 220, the PCB layer 230, and other components of the mobile device 200 that may or may not be on the PCB layer 230. For example, the housing may retain (e.g., hold, contain) or be integrated with antenna systems, front-end circuits, an intermediate-frequency circuit, and a processor discussed below. The housing may be substantially rectangular, having two sets of parallel edges in the illustrated embodiment, and may be configured to bend or fold. In this example, the housing has rounded corners, although the housing may be substantially rectangular with other shapes of corners, e.g., straight-angled (e.g., 45°) corners, 90°, other non-straight corners, etc. Further, the size and/or shape of the PCB layer 230 may not be commensurate with the size and/or shape of either of the top or bottom covers or otherwise with a perimeter of the device. For example, the PCB layer 230 may have a cutout to accept a battery. Further, the PCB layer 230 may include sandwiched boards and/or a PCB daughter board. Daughter boards may be chosen to facilitate a design and/or manufacturing process, e.g., to reinforce a functional separation or to better utilize a space in the housing. Embodiments of the PCB layer 230 other than those illustrated may be implemented.

The limited space available in a UE (e.g., a smartphone, tablet computer, etc.) presents antenna design challenges. For example, with 10 or more antennas for LTE, sub-6 GHz band, and SPS (Satellite Positioning System) (e.g., GPS (Global Positioning System) in a mobile phone, there may be no additional space available for another antenna. Because antenna frequency bandwidth varies with antenna size, with small antennas typically having narrow bandwidths, designing a stand-alone antenna to cover a wide frequency bandwidth is challenging.

As used herein, the term “user equipment” and “UE” are not specific to or otherwise limited to any particular Radio Access Technology (RAT), unless otherwise noted. In general, UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, or another short-range wireless protocol) and so on. Further, two or more UEs may communicate directly in some configurations with or without passing information to each other through a network.

UEs have a limited number an antennas to support significant, varied (and increasing) wireless signaling functionality. Antenna elements may be shared between different radio access technologies (RATs) in order to support numerous technologies in limited space. By tuning an antenna (comprising one or more antenna elements), antenna efficiency may be improved, e.g., by 3 dB or more, for active technologies. An antenna tuner may comprise multiple tuning circuits to help tune multiple different antennas, e.g., for different RATs, different frequency bands (for different RATs or the same RAT), etc. An antenna tuner may be controlled by one radio of a UE even though the antenna tuner can tune antennas for multiple RATs. If the UE is in low-power mode (LPM, also called power saving mode (PSM), such as an airplane mode (APM)) where at least one RAT is inactive and powered down, then adjusting the tuner may be undesirable if the inactive RAT is the RAT that controls the antenna tuner. Techniques are discussed herein for controlling waking up of an antenna tuner that is inactive (powered down).

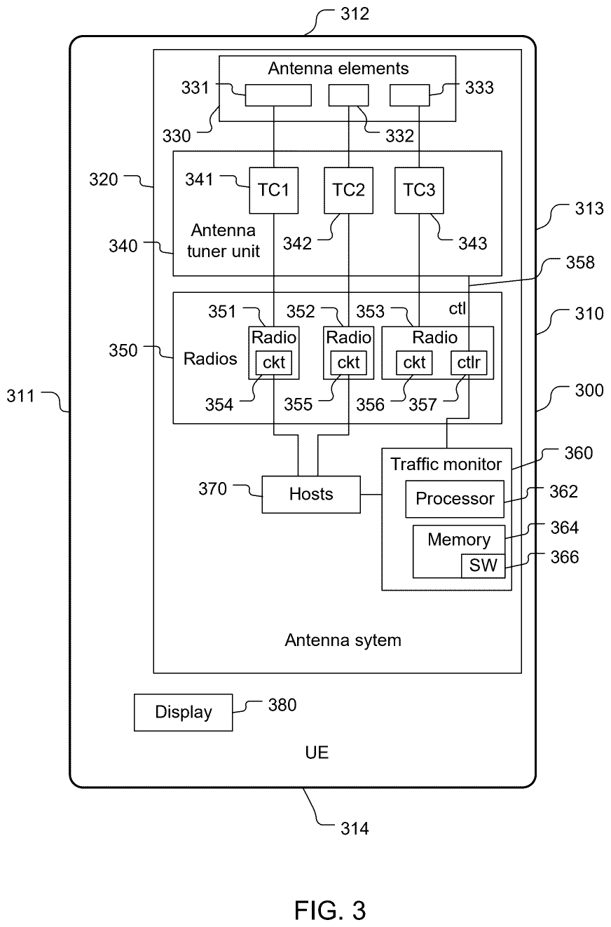

Referring also to FIG. 3, a UE 300 includes a body 310 and an antenna system 320 that includes an antenna element section 330, an antenna tuner unit 340, a radio section 350, a signal traffic monitor 360, and hosts 370. Although one antenna system 320 is shown in FIG. 3, more than one antenna system (with one or more antenna system configurations) may be included in the UE 300. Also, in this example, there are three radios and two hosts, each corresponding to a respective radio, but other quantities of radios and hosts may be included in a UE.

The antenna element section 330 includes, in this example, antenna elements 331, 332, 333. Even if referred to in the singular, one or more of the antenna elements 331, 332, 333 may comprise multiple antenna elements (e.g., multiple conductors). The antenna elements 331, 332, 333 may be disposed at least proximate to at least one edge of multiple edges 311, 312, 313, 314 of the body 310. For example, the antenna elements 331, 332, 333 may be disposed proximate to (near but separated from) the edge 312. As another example, the antenna element 332 could form a portion of one or more of the edges 311-314, or be disposed proximate to multiple edges (e.g., two edges) of the edges 311-314, or form a portion of one of the edges 311-314 and be disposed proximate to another one of the edges 311-314.

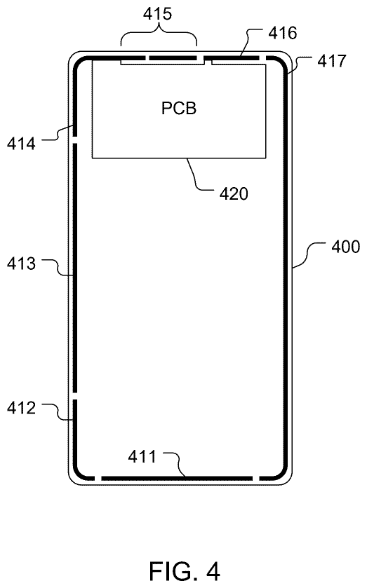

Referring also to FIG. 4, a UE 400, which is an example of the UE 300, includes multiple antenna elements 411, 412, 413, 414, 415, 416, 417 corresponding to respective antennas, and a PCB 420 (Printed Circuit Board). The PCB 420 may include circuitry of one or more antennas, e.g., of an antenna comprising the antenna element 415 (which is an example of a segmented antenna element comprising at least a portion of each of two or more antenna element conductors).

Referring again in particular to FIG. 3, the antenna tuner unit 340 includes multiple tuning circuits 341, 342, 343 (also called antenna tuners) each communicatively coupled to a respective one of the antenna elements 331-333, in this example. In other examples, the tuning circuits 341, 342 may be coupled to a shared antenna element (e.g., the antenna element 331 alone) instead of the separate antenna elements 331, 332. Multiple tuning circuits may be coupled to the same antenna element, with the antenna element being shared between radio access technologies. In the example shown in FIG. 3, the tuning circuits 342, 343 are both communicatively coupled to the antenna element 332, with the antenna element 332 thus being a shared antenna element. Each of the tuning circuits 341-343 is configured to selectively provide one of multiple possible respective impedances in order to improve antenna performance, e.g., based on a frequency of a signal to be transmitted and/or received by a respective antenna element. Each of the tuning circuits 341-343 is configured to provide a respective RF (Radio Frequency) transmit signal to, and/or receive a respective RF reception signal from, a respective antenna element.

The radio section 350 includes multiple radios, here radios 351, 352, 353, although this is an example and other quantities of radios may be included in the radio section 350. Each of the radios 351-353 includes respective signaling circuitry 354, 355, 356. The signaling circuitry 354-356 is configured to provide at least one transmit signal to, and/or receive and process at least one RF reception signal from, a respective tuning circuit (here, the tuning circuits 341-343, respectively) of the antenna tuner unit 340. The radio section 350 may be disposed on (e.g., comprise a portion of) a PCB (Printed Circuit Board). Portions of the radio section 350 may be disposed on respective integrated circuit (IC) chips. For example, the radios 351, 352 may be disposed on one IC chip and the radio 353 may be disposed on a separate IC chip.

The respective signaling circuitry 354-356 of the radios 351-353 is configured to support respective RATs. For example, each of the radios 351, 352 may be configured to support a Bluetooth®, WLAN, UWB (Ultrawideband), and/or GNSS, etc. RAT and the radio 353 may be configured to support a WWAN (Wireless Wide Area Network) RAT. For example, the radios 351, 352 may support WLAN/BT 2.4 GHz and WLAN/BT 5/6 GHz, respectively. Each of the radios comprise transmission components for producing and transmitting one or more transmit signals to the antenna tuner unit 340 and/or comprise reception components for receiving and processing one or more reception signals received from the antenna tuner unit 340. Transmission components may include an oscillator, a power amplifier, a mixer, and a processor to provide a signal to be mixed by the mixer with a signal from the oscillator. Reception components may include an LNA (Low-Noise Amplifier), a mixer, an oscillator, and a processor (which may be shared with the monitor 360) to decode the reception signal amplified by the LNA, and downconverted in frequency by the mixer and the oscillator. The signaling circuitry 354-356 may comprise transmission components for one or more frequency bands and/or reception components for one or more frequency bands.

The radio 353 also includes an antenna tuner controller 357. As discussed below, the traffic monitor 360 may determine the desired antenna tuning and instruct the controller 357 as to the desired antenna tuning, and the controller 357 may respond to instruction from the monitor 360 by waking up and providing one or more appropriate control signal(s) 358 to the antenna tuner unit 340 to implement the desired antenna tuning. The control signal(s) 358 may, for example, cause one or more switches of the antenna tuner unit 340 to open or close, respectively, to adjust an impedance to a desired impedance to increase or decrease, as appropriate, the respective antenna performance. Alternatively, the controller 357 may comprise a processor and memory, e.g., as discussed below with respect to the traffic monitor 360, configured to determine desired antenna tuning (as discussed herein) and provide the control signal(s) 358 to the antenna tuner unit 340 to control the antenna tuner unit 340 to implement the desired antenna tuning.

The traffic monitor 360 may include a processor 362 (that may include one or more hardware devices, e.g., a central processing unit (CPU), a microcontroller, an application specific integrated circuit (ASIC), etc.) and a memory 364. The processor 362 may comprise multiple processors including a general-purpose/application processor, a Digital Signal Processor (DSP), a modem processor, a video processor, and/or a sensor processor. The memory 364 may be a non-transitory, processor-readable storage medium that may include random access memory (RAM), flash memory, disc memory, and/or read-only memory (ROM), etc. The memory 364 may store software 366 which may be processor-readable, processor-executable software code containing instructions that may be configured to, when executed, cause the processor 362 to perform various functions described herein. Alternatively, the software 366 may not be directly executable by the processor 362 but may be configured to cause the processor 362, e.g., when compiled and executed, to perform the functions. The description herein may refer to the monitor 360 performing a function, but this includes other implementations such as where the processor 362 executes instructions of software and/or firmware. The description herein may refer to the UE 300 performing a function as shorthand for one or more appropriate components of the UE 300 performing the function. The processor 362 may include a memory with stored instructions in addition to and/or instead of the memory 364. Even if referred to in the singular, the processor 362 may include more than one processor and the memory 364 may include more than one memory.

The monitor 360 is communicatively coupled to the radio section 350 and configured to monitor signal traffic of the radio section 350, determine desired antenna tuning, and instruct the controller 357 to implement the desired antenna tuning. The monitor 360 may monitor signal traffic of the radio section 350 during a normal activity mode and during a low-power mode (LPM). During the LPM, at least the radio that includes the antenna tuner controller is inactive (powered OFF, asleep) and only wakes up in response to a wake-up command. In the example of the UE 300, at least the radio 353 (for WWAN) is inactive in the LPM. There may or may not be one or more radios that are active/ON during the LPM. The monitor 360 is configured to monitor signal traffic of the radio section 350 during the LPM, with the signal traffic including amount(s) of traffic (i.e., a traffic level (e.g., transmit and/or receive (Tx/Rx) packets per second for each active radio)), operating frequency channel/band, traffic type (e.g., gaming, audio streaming, web browsing, etc.), etc. A Tx/Rx traffic level may be referred to as a Tx/Rx activity level or a packet transfer level. The monitor 360 may monitor traffic only for active/ON radios.

The monitor 360 may monitor and/or store other information related to desired antenna tuning. For example, the monitor 360 may monitor whether a display 380 of the UE 300 is ON or OFF. The monitor 360 may also store (e.g., in the memory 364) information as to a priority policy for radios of the radio section 350. For example, the monitor 360 may store a priority for radios other than a radio that includes an antenna tuner controller, in this example, storing a priority policy for the radios 351, 352. The monitor 360 may store (e.g., in the memory 364) information as to which RATs have separate (non-shared) antennas and which RAT(s), if any, has/have shared antennas.

The hosts 370 may provide information regarding the respective RATs/radios to the monitor 360. For example, a host for each of the radios 351, 352 may provide respective information as to Tx/Rx activity, operation channel/band, and traffic type.

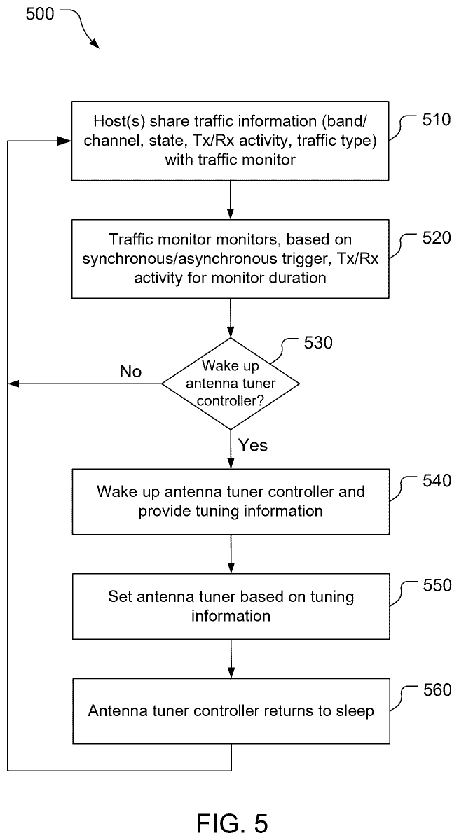

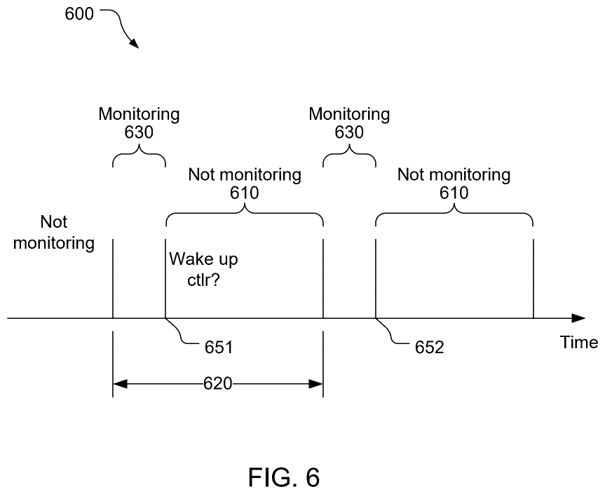

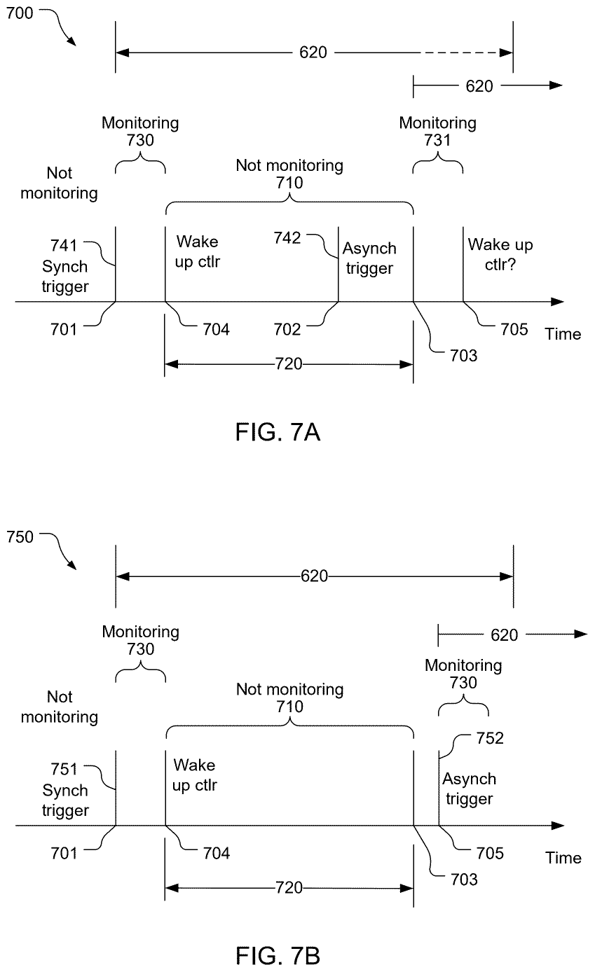

Referring also to FIG. 5 with further reference to FIG. 6, FIG. 7A, and FIG. 7B, a method 500 for determining and implementing desired antenna tuning while the UE 300 is in the LPM includes the stages shown. FIG. 6 shows a timing diagram 600 for synchronous activity monitoring, and FIG. 7A and FIG. 7B showing timing diagrams 700, 750 for asynchronous activity monitoring, with each of the diagrams 600, 700, 750 having periods of no traffic activity monitoring and periods of traffic activity monitoring, and decision points for waking up an antenna tuner controller. The method 500 is, however, an example and not limiting. The method 500 may be altered, e.g., by having one or more stages added, removed, rearranged, combined, performed concurrently, and/or having one or more single stages split into multiple stages. In the method 500, one or more inputs (e.g., of Tx/Rx activity, operating channel/band, traffic type, display ON/OFF status, RAT priority, and shared/non-shared antenna) are used to determine whether to wake up an antenna tuner controller and, if so, what antenna tuning to implement.

At stage 510, one or more of the hosts 370 shares traffic information with the traffic monitor 360. For example, a host for each radio that does not include the antenna tuner controller (here, the radios 351, 352) may provide traffic information to the traffic monitor 360 that might affect what antenna tuning to implement. For example, the traffic information may include the channel/frequency band presently in use by the respective radio, a state (ON or OFF/idle) of the respective radio, Tx/Rx activity (e.g., packets per second, or an indication of high-activity/low-activity), and/or traffic type (e.g., gaming, audio streaming, video streaming, web browsing, etc.), etc. The channel/band, radio state, and/or traffic type may be shared with the traffic monitor 360 asynchronously, e.g., based on a change in the respective information. During stage 510, the traffic monitor 360 may monitor a state of the display 380 of the UE 300, i.e., whether the display 380 is ON or OFF. Stage 510 may correspond to one or more durations 610 where the traffic monitor 360 is not monitoring Tx/Rx activity of the radios corresponding to the hosts 370.

At stage 520, the traffic monitor 360 monitors, in response to a synchronous or asynchronous trigger, the Tx/Rx activity on any of the radios not including the antenna tuner controller, here the radios 351, 352, that are presently active. For example, for synchronous triggering, the monitor 360 may initiate monitoring of an active/connected radio based on passage of a traffic monitor period 620 passing since a most-recent time at which the monitor 360 initiated Tx/Rx monitoring. Alternatively, the monitor 360 may initiate monitoring of an active/connected radio based on passage of a traffic monitor period passing since a most-recent time at which the monitor 360 ended Tx/Rx monitoring. The traffic monitor period 620 may, for example, be about 60 seconds such that the monitor 360 will wake up every 60 seconds to monitor the Tx/Rx activity of the active radio(s) 351, 352, if any. This will help avoid the monitor 360 waking up too often while the UE 300 is in the LPM. The traffic monitor period 620 may be dynamically configured, e.g., to lengthen the traffic monitor period 620 (e.g., by a set amount of time, or a percentage of the previous value of the traffic monitor period 620) based on the antenna tuner controller 357 having not been woken up for a threshold number of the traffic monitor periods 620, or to shorten the traffic monitor period 620 (e.g., by a set amount of time, or a percentage of the previous value of the traffic monitor period 620) based on the antenna tuner controller 357 being woken up frequently. There may be an upper limit and/or a lower limit on the value of the traffic monitor period 620. The amount by which the traffic monitor period 620 is lengthened or shortened may be static or dynamic (e.g., based on a status of the display 380, e.g., lengthening more or shortening less if the display 380 is OFF, or lengthening less or shortening more if the display 380 is ON). For example, the traffic monitor period 620 may be lengthened to avoid exceeding a threshold frequency of wake-ups (e.g., to avoid exceeding a threshold quantity of monitor wake-ups within a threshold time window).

For asynchronous monitoring, as shown in FIG. 7A and FIG. 7B, the monitor 360 may initiate monitoring based on a synchronous trigger event, or based on an asynchronous trigger event after a wake-up time threshold has passed since the most recent antenna tuner controller wake up. The wake-up time threshold is used to avoid waking up the antenna tuner controller too often (i.e., exiting a not-monitoring mode 710 too early). In the example of FIG. 7A, a synchronous trigger 741 occurs at a time 701. In response to the synchronous trigger 741, the monitor 360 monitors Tx/Rx traffic of any active radio of the radios 351, 352 (i.e., any active radios other than the radio 353 that includes the antenna tuner controller 354) for a monitor duration 730 beginning at the time 701 (plus any reaction time of the monitor 360). At the end of the monitor duration 730 at a time 704, the monitor 360 decides whether to wake up the antenna tuner controller 357 based on whether there has been a change in Tx/Rx activity of any of non-antenna-tuner-controlling radio warranting a wake up of the antenna tuner controller 357. If, as in this case, the monitor 360 wakes up the antenna tuner controller 357 at the time 704, then the monitor 360 will not wake up the antenna tuner controller 357 again for at least a wake-up time threshold 720 after the time 704, and thus the monitor 360 ceases monitoring the Tx/Rx activity at least until the timer reaches a wake-up time threshold 720. As with the traffic monitor period 620, the threshold 720 may be dynamically configured, e.g., being made longer or shorter, e.g., to avoid exceeding a threshold quantity of antenna tuner controller wake-ups within a threshold time window. A next monitoring duration will not be triggered before the wake-up time threshold 720 is reached. Thus, if, as in this example, an asynchronous trigger event 752 occurs at a time 702, before the wake-up time threshold 720 is reached, monitoring is not triggered at the time 702. Once the wake-up time threshold 720 is reached at a time 703, a new round of Tx/Rx activity monitoring is triggered, starting at the time 703, and the traffic monitor period 620 is re-started. If, as shown in FIG. 7B, the antenna tuner controller 357 is woken up at the time 704, no asynchronous trigger is received before expiration of the wake-up time threshold 720, but an asynchronous trigger 752 is received at a time 705 after expiration of the wake-up time threshold 720 (and before expiration of the traffic monitor period 620), then a new monitor period 730 is started at the time 705 (e.g., as soon as possible thereafter). If no asynchronous trigger is received before the traffic monitor period 620 is reached, then another synchronous trigger initiates monitoring of the Tx/Rx activity.

An asynchronous trigger event may be any of a variety of events that warrant waking up the monitor 360 and monitoring Tx/Rx activity. For example, a change in channel/frequency band of one of the radios 351, 352 may trigger asynchronous Tx/Rx activity monitoring. As another example, a change in active/inactive status of any of the radios 351, 352 may be an asynchronous event trigger. As another example, a change in traffic type on any of the radios 351, 352 may be an asynchronous event trigger.

Once triggered, the monitor 360 may be configured to monitor the Tx/Rx activity of any active radio of the radios 351, 352 (e.g., via the respective host(s) of the hosts 370) for a synchronous monitor duration 630 or an asynchronous monitor duration 730. The durations 630, 730 may be the same or different. The synchronous monitor duration 630 may be significantly shorter than the traffic monitor period 620. For example, the monitor duration 630 may be less than one-fifth of the traffic monitor period, e.g., about 10 seconds. Similarly, the asynchronous monitor duration 730 may be significantly shorter than the wake-up time threshold 720. For example, the wake-up time threshold 720 may be about 50 seconds (e.g., as a default) and the asynchronous monitor duration 730 may be less than about one-fifth of the traffic monitor period, e.g., about 10 seconds. The duration 630 and/or the duration 730 may be a static amount of time or the duration 630 and/or the duration 730 may be dynamically determined, e.g., as a percentage of the period 620 or a percentage of the threshold 720, respectively. The duration 630 and/or the duration 730 may be depend on an ON/OFF status of a display 380 of the UE 300, e.g., being shorter if the display 380 is OFF and longer if the display 380 is ON.

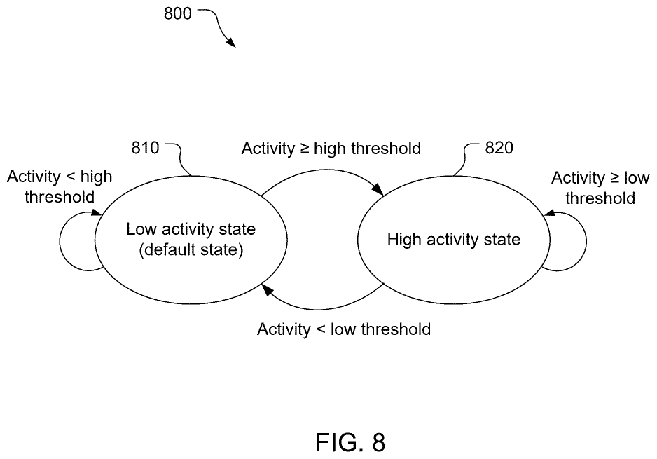

Referring also to FIG. 8, a state diagram 800 shows multiple states of Tx/Rx activity. The monitor 360 (or the respective host(s) of the hosts 370) may categorize the Tx/Rx activity of a radio into one of multiple states, in this example one of a low activity state 810 or a high activity state 820. For example, the monitor 360 may compare the Tx/Rx activity against different thresholds to provide hysteresis between the states 810, 820. The monitor 360 may consider, as a default, the monitored radio to be in the low state 810 as long as the Tx/Rx activity (e.g., packets per second) is less than a high threshold (e.g., X packets per second), and to move to the high state 820 based on the Tx/Rx activity meets or exceeds the high threshold. Once in the high state 820, the monitor 360 may consider the monitored radio to remain in the high state 820 while the Tx/Rx activity is at or above a low threshold (e.g., Y packets per second, where Y<X), and to return to the low state 810 based on the Tx/Rx activity dropping below a low threshold. A value of the high threshold and/or a value of the low threshold may be dynamically determined, e.g., based on an ON/OFF state of the display 380.

Referring again in particular to FIG. 5, FIG. 6, and FIG. 7, with further reference to FIG. 3, at the end of a monitor duration, e.g., at a time 651, 652 of the monitor duration 630 or at a time 704, 705 of the monitor duration 730, the method 500 proceeds to stage 530 where the monitor 360 determines whether to wake up the antenna tuner controller 357 and have the antenna tuner controller 357 adjust one or more impedances of one or more of the tuning circuits 341, 342. For example, the monitor 360 may determine to wake up the antenna tuner controller 357 based on there having been a change in the Tx/Rx activity (e.g., activity state), operating channel/band, and/or traffic type for any of the monitored radio(s) that warrants a change in antenna tuning. As another example, the monitor 360 may determine not to wake up the antenna tuner controller 357 based on there not having been any change, or there not having been a change in the Tx/Rx activity (e.g., activity state), operating channel/band, and/or traffic type for any of the monitored radio(s) that warrants a change in antenna tuning. Even though there may have been an asynchronous event trigger that warranted waking up the monitor 360, there may not have been a change (at least by the end of the monitor duration 630, 730) in traffic (e.g., Tx/Rx activity, channel/band, traffic type, etc.) significant enough to warrant a change in antenna tuning. Alternatively, the monitor 360 may be configured not to wake up unless a change in antenna tuning (and thus waking up of the antenna tuner controller 357) is warranted. The monitor 360 may wait until the end of the monitor duration 630, 730 to help ensure that a change is not fleeting, e.g., to avoid waking up the antenna tuner controller 357 for a change that does not last long.

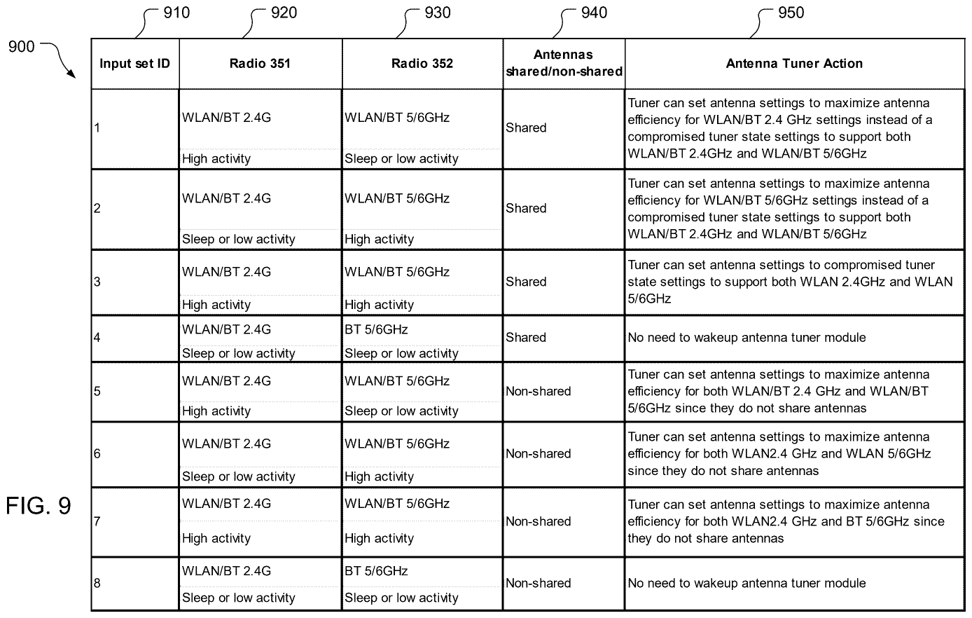

Referring also to FIG. 9, to determine whether a change in antenna tuning is warranted, the monitor 360 may, for example, compare the status of the input values against a look-up table with different sets of values and corresponding antenna tuner settings. If the monitor 360 determines that the present set of input values corresponds to a different antenna tuner setting than a present setting, then the monitor 360 determines to wake up the antenna tuner controller 357 and cause a change in the antenna tuning provided by the antenna tuner unit 340. For example, an LUT 900 (Look-Up Table) includes setting IDs 910, Tx/Rx activity level input values 920 for the radio 351, Tx/Rx activity level input values 930 for the radio 352, shared/non-shared antenna element indicators 940, and corresponding antenna tuner settings 950. The LUT 900 may take account of priorities between radios (e.g., priorities of RATs of the radios). The LUT 900 is an example, and other LUTs may be used. For example, an LUT may be used that includes values of inputs other than ON/OFF/idle status and Tx/Rx activity level, e.g., also or alternatively including channel/band for the respective radio/antenna and/or traffic type for the respective radio/antenna and/or one or more parameters affecting desired antenna tuning. As another example, an LUT used may not include entries for conditions that cannot exist for the UE, e.g., for shared antennas if the UE uses separate antennas for the radios 351, 352. Using the LUT 900, if the monitor 360 determines that the present conditions correspond, for example, to input set ID number 2, but the present antenna tuner settings correspond to input set ID number 4, then the monitor 360 may determine, at stage 530, to wake up the antenna tuner controller 357. If the monitor 360 determines not to wake up the antenna tuner controller 357, then the method 500 returns to stage 520. If the monitor 360 determines to wake up the antenna tuner controller 357, then the method 500 proceeds to stage 540.

At stage 540, the monitor 360 wakes up the antenna tuner controller 357 and provides tuning information to the antenna tuner controller 357. The antenna tuner controller 357 may use the tuning information to determine and provide the control signal(s) 358 to the antenna tuner unit 340 to implement desired antenna tuning. For example, the monitor 360 may share the input values from the hosts 370 or may instruct the antenna tuner controller 357 what antenna tuning to implement, e.g., per the antenna tuner settings 950 corresponding to the present input values. For example, the monitor 360 may provide instructions, e.g., the antenna tuner settings 950, to the antenna tuner controller 357, e.g., without waking up (powering up) the signaling circuitry 356. As another example, the monitor 360 may provide the input values (e.g., Tx/Rx activity, operating channel/band, traffic type, priority policy for the radios/RATs, shared v. non-shared antenna context, display ON/OFF status, etc.) for the antenna tuner controller 357 to use to determine the antenna tuning to implement (e.g., using the LUT 900).

At stage 550, the antenna tuner controller 357 sets the antenna tuning based on the instruction/information received at stage 540. For example, the antenna tuner controller 357 converts the instructions of the antenna tuner settings 950 into the control signal(s) 358 that the antenna tuner controller 357 sends to the antenna tuner unit 340 for the appropriate tuning circuit(s) 341, 342. As another example, the controller 357 determines the antenna tuner settings by analyzing the input values provided by the monitor 360 and converts the antenna tuner settings into the control signal(s) 358 that the antenna tuner controller 357 sends to the antenna tuner unit 340 for the appropriate tuning circuit(s) 341, 342.

At stage 560, the antenna tuner controller 357 returns to sleep. For example, once the antenna tuning has been adjusted by the antenna tuner unit 340, or at least after the antenna tuner unit 340 has been instructed by the controller 357 as to what antenna tuning to implement, the controller 357 returns to sleep to save power. The method 500 may return to stage 510 for further waking up of the monitor 360 (or determination to wake up the monitor 360).

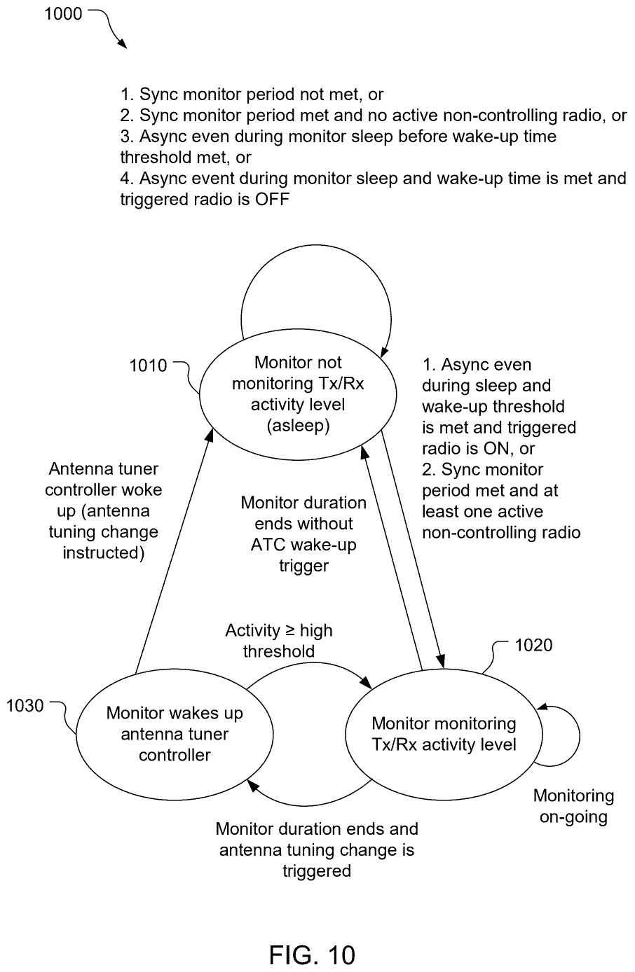

Referring also to FIG. 10, a state diagram 1000 shows states of the monitor 360 and the antenna tuner controller 357, and transitions between the states. The diagram 1000 is an example, and other state diagrams, e.g., with different conditions for changing between states, may be used.

The UE 300 may be in a non-monitoring state 1010 where the monitor 360 is asleep and not monitoring Tx/Rx activity of any radio, but is monitoring traffic information provided by the hosts 370, e.g., to determine (if the UE 300 is in asynchronous monitoring mode) whether an asynchronous trigger even occurs. The UE 300 may remain in the state 1010 if (1) the UE 300 is in synchronous monitor mode, the synchronous traffic monitor period 620 is running and has not yet been met, or (2) the UE 300 is in synchronous monitor mode, the synchronous traffic monitor period 620 has been met, but there is no active non-antenna-tuner-controlling radio, or (3) the UE 300 is in asynchronous monitor mode and the monitoring wake-up time threshold 720 has not been met (even if an asynchronous event has occurred), or (4) the UE 300 is in asynchronous monitor mode, the monitoring wake-up time threshold 720 has been met, and an asynchronous event has not occurred or an asynchronous event has occurred but a triggered radio is OFF/idle (that is, a radio that was previously triggered, and thus turned ON, has turned OFF/idle by the time the monitoring wake-up time threshold 720 has been met).

The UE 300 may change from the non-monitoring state 1010 to a monitoring state 1020 where the monitor 360 monitors the Tx/Rx activity level of at least one non-antenna-tuner-controlling radio. The change from the state 1010 to the state 1020 may be triggered by (1) the UE 300 being in asynchronous monitor mode, the monitoring wake-up time threshold 720 having been met, an asynchronous event occurring, and a triggered radio being ON, or (2) the UE 300 is in synchronous monitor mode, the synchronous traffic monitor period 620 has been met, and there is at least one active non-antenna-tuner-controlling radio. The UE 300 remains in the monitoring state 1020 while the monitoring of Tx/Rx activity level by the monitor 360 is on-going, i.e., during the monitor duration 630, 730.

The UE 300 may change from the monitoring state 1020 back to the non-monitoring state 1010 or to an antenna tuner controller (ATC) wake-up state 1030. For example, the UE 300 may change from the monitoring state 1020 back to the non-monitoring state 1010 based on the monitor duration 630, 730 expiring and no ATC wake-up being triggered, i.e., no traffic status change being detected that warrants a change in antenna tuning. As another example, the UE 300 may change from the monitoring state 1020 to the ATC wake-up state 1030 based on the monitor duration 630, 730 ending and traffic status change being detected that warrants a change in antenna tuning.

At the ATC wake-up stage 1030, the antenna tuner controller 357 is woken up and implements a change in antenna tuning. For example, as discussed above, the controller 357 may implement antenna tuning instructed by the monitor 360, or may determine antenna tuning based on information provided by the monitor 360 and implement the determined antenna tuning. Based on the controller 357 being woken up, the UE 300 may return to the non-monitoring state 1010 where the monitor 360 is asleep at least for the traffic monitor period 620 or the monitoring wake-up time threshold 720, respectively (depending on whether the UE 300 is in synchronous monitoring mode or asynchronous monitoring mode). The antenna tuner controller 357 (e.g., the radio 353) may be put back to sleep based on the new antenna tuning being implemented, which may help improve antenna performance (e.g., by up to 3 dB of antenna efficiency) for a desired radio based on the inputs affecting desired antenna tuning.

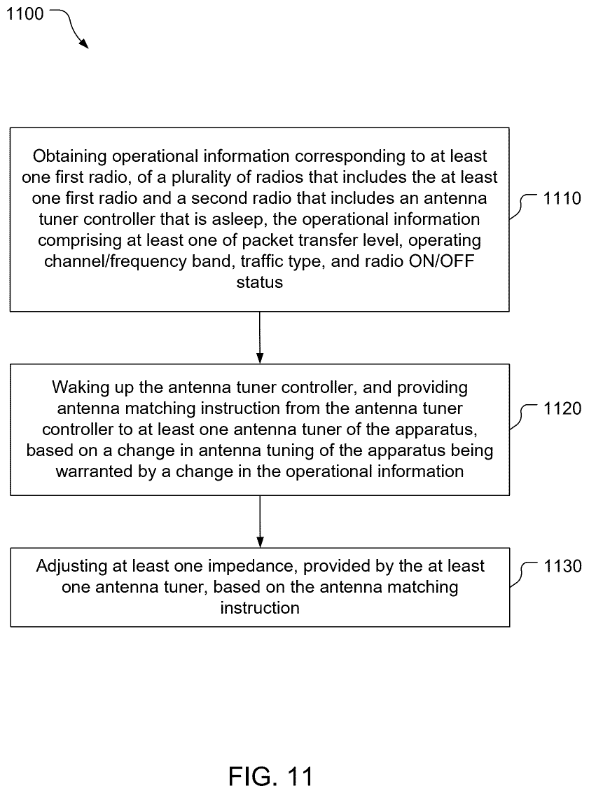

Referring to FIG. 11, with further reference to FIGS. 1-10, a method 1100 of antenna tuning of an apparatus that is in a low-power mode includes the stages shown. The method 1100 is, however, an example and not limiting. The method 1100 may be altered, e.g., by having one or more stages added, removed, rearranged, combined, performed concurrently, and/or having one or more single stages split into multiple stages.

At stage 1110, the method 1100 includes obtaining operational information corresponding to at least one first radio, of a plurality of radios that includes the at least one first radio and a second radio that includes an antenna tuner controller that is asleep, the operational information comprising at least one of packet transfer level, operating channel/frequency band, traffic type, and radio ON/OFF status. For example, at stage 510 and/or stage 520 the monitor 360 obtains operational information, e.g., from one or more of the hosts 370 and/or from traffic monitoring of one or more of the radios 351, 352 (e.g., any active radio that does not include an antenna tuner controller that is asleep). The processor 362, possibly in combination with the memory 364, in combination with one or more of the hosts 370 and/or one or more of the radios 351, 352 may comprise means for obtaining the operational information. The operational information may include ON/OFF status of a radio, e.g., whether a particular radio is ON or OFF/idle.

At stage 1120, the method 1100 includes waking up the antenna tuner controller, and providing an antenna matching instruction from the antenna tuner controller to at least one antenna tuner of the apparatus, based on a change in antenna tuning of the apparatus being warranted by a change in the operational information. For example, at stage 540 the monitor 360 wakes up the antenna tuner controller 357 based on desired antenna tuning change (e.g., from favoring one antenna to favoring another antenna to improve the antenna efficiency of the other antenna) and provides tuning information to the antenna tuner controller 357, which may use the tuning information to determine and provide the control signal(s) 358 to the antenna tuner unit 340 to implement desired antenna tuning. The processor 362, possibly in combination with the memory 364, in combination with the antenna tuner controller 357 (e.g., possibly a processor, possibly in combination with a memory) may comprise means for waking up the antenna tuner controller.

At stage 1130, the method 1100 includes adjusting at least one impedance, provided by the at least one antenna tuner, based on the antenna matching instruction. For example, at stage 550 one or more of the tuning circuits 341, 342 changes an impedance, e.g., to reduce or improve antenna efficiency, based the control signal(s) from the antenna tuner controller 357. The antenna tuner controller 357 (e.g., possibly a processor, possibly in combination with a memory) in combination with one or more of the tuning circuits 341, 342 may comprise means for adjusting the at least one impedance.

Implementations of the method 1100 may include one or more of the following features. In an example implementation, the method 1100 further includes: providing the operational information to the antenna tuner controller; and determining the antenna matching instruction by the antenna tuner controller based on the operational information. For example, at stage 540, instead of providing instructions as to which antenna tuning to implement, the monitor 360 may provide operational information, from which an antenna tuning setting may be determined, to the antenna tuner controller 357 and the antenna tuner controller 357 may determine the antenna tuning to implement (e.g., an antenna setting from the LUT 900). The monitor 360, e.g., the processor 362 possibly in combination with the memory 364, may comprise means for providing the operational information and the antenna tuner controller 357 (e.g., possibly a processor, possibly in combination with a memory) may comprise means for determining the antenna matching instruction. In a further example implementation, the method 1100 may include putting the antenna tuner controller to sleep based on providing the antenna matching instruction from the antenna tuner controller. For example, the antenna tuner controller 357 may put itself back to sleep based on sending the control signal(s) 358 to the antenna tuner unit 340, or the monitor 360 may instruct, based on sending the control signal(s) 358 being sent to the antenna tuner unit 340, the antenna tuner controller 357 to go back to sleep. The monitor 360, e.g., the processor 362 possibly in combination with the memory 364, or the antenna tuner controller 357 possibly a processor, possibly in combination with a memory) may comprise means for putting the antenna tuner controller to sleep.

Also or alternatively, implementations of the method 1100 may include one or more of the following features. In an example implementation, the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state. For example, a change between the states 810, 820 may trigger waking up the antenna tuner controller 357 and changing the antenna tuning. In another example implementation, obtaining the operational information comprises intermittently monitoring the packet transfer level of each active radio of the at least one first radio. For example, the monitor 360 may intermittently (e.g., periodically or aperiodically monitor the Tx/Rx activity of any active radio of the radios 351, 352 (or other active non-antenna-controller-containing radio). In a further example implementation, the intermittently monitoring comprises periodically monitoring. For example, the monitor 360 may be in synchronous monitoring mode and trigger monitoring upon expiration of the traffic monitor period 620.

Also or alternatively, implementations of the method 1100 may include one or more of the following features. In an example implementation, at least one of a packet transfer level threshold for determining the change in the operational information, a periodicity of monitoring packet transfer level for obtaining the operational information, a threshold time between asynchronous monitoring instances, and a duration of monitoring the packet transfer level depends on an ON/OFF state of a display of the apparatus. For example, the high Tx/Rx activity level threshold, the low Tx/Rx activity level threshold, the traffic monitor period 620, the monitor duration 630, the monitoring wake-up time threshold 720, and/or the monitor duration 730 may be dependent on whether the display 380 is ON or OFF. In another example implementation, obtaining the operational information comprises monitoring the packet transfer level of each active radio of the at least one first radio based on a threshold time having passed since a most-recent wake-up of the antenna tuner controller. For example, the monitor 360 may not monitor Tx/Rx activity level until passage of the traffic monitor period 620, if the UE 300 is in synchronous monitoring mode, or the monitoring wake-up time threshold 720 if the UE is in asynchronous monitoring mode. In another example implementation, obtaining the operational information comprises monitoring the packet transfer level of each active radio of the at least one first radio based on occurrence of an asynchronous event trigger. For example, the monitor 360 triggers monitoring Tx/Rx activity level based on an asynchronous event trigger occurring (e.g., after passage of the monitoring wake-up time threshold 720). In a further example implementation, the asynchronous event trigger comprises at least one of: frequency change of at least one of the at least one first radio; change between ON state and OFF/idle state of at least one of the at least one first radio; and traffic type change of at least one of the at least one first radio. For example, a radio may change from ON to OFF, but there can still be one or more other active radios, and the active radio(s) can gain priority when one radio enters OFF state. Radios may be tracked independently and tuner programming may be determined based on a configuration across radios.

### Implementation examples

Implementation examples are provided in the following numbered clauses.
Clause 1. A method of antenna tuning of an apparatus that is in a low-power mode, the method comprising:
obtaining operational information corresponding to at least one first radio, of a plurality of radios that includes the at least one first radio and a second radio that includes an antenna tuner controller that is asleep, the operational information comprising at least one of packet transfer level, operating channel/frequency band, traffic type, and radio ON/OFF status;
waking up the antenna tuner controller, and providing an antenna matching instruction from the antenna tuner controller to at least one antenna tuner of the apparatus, based on a change in antenna tuning of the apparatus being warranted by a change in the operational information; and
adjusting at least one impedance, provided by the at least one antenna tuner, based on the antenna matching instruction.
Clause 2. The method of clause 1, further comprising:
providing the operational information to the antenna tuner controller; and
determining the antenna matching instruction by the antenna tuner controller based on the operational information.
Clause 3. The method of either of clause 1 or clause 2, further comprising putting the antenna tuner controller to sleep based on providing the antenna matching instruction from the antenna tuner controller.
Clause 4. The method of any of clauses 1-3, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.
Clause 5. The method of any of clauses 1-4, wherein obtaining the operational information comprises intermittently monitoring the packet transfer level of each active radio of the at least one first radio.
Clause 6. The method of clause 5, wherein the intermittently monitoring comprises periodically monitoring.
Clause 7. The method of any of clauses 1-4, wherein at least one of a packet transfer level threshold for determining the change in the operational information, a periodicity of monitoring packet transfer level for obtaining the operational information, a threshold time between asynchronous monitoring instances, and a duration of monitoring the packet transfer level depends on an ON/OFF state of a display of the apparatus.
Clause 8. The method of any of clauses 1-7, wherein obtaining the operational information comprises monitoring the packet transfer level of each active radio of the at least one first radio based on a threshold time having passed since a most-recent wake-up of the antenna tuner controller.
Clause 9. The method of any of clauses 1-4, 7, or 8, wherein obtaining the operational information comprises monitoring the packet transfer level of each active radio of the at least one first radio based on occurrence of an asynchronous event trigger.
Clause 10. The method of clause 9, wherein the asynchronous event trigger comprises at least one of: frequency change of at least one of the at least one first radio; change between ON state and OFF/idle state of at least one of the at least one first radio; and traffic type change of at least one of the at least one first radio.
Clause 11. A wireless signaling apparatus comprising:
at least one antenna;
a plurality of radios each corresponding to a respective radio access technology and each communicatively coupled to a respective one of the at least one antenna, the plurality of radios comprising at least one first radio, and a second radio that includes an antenna tuner controller and is configured to be asleep in a low-power mode of the wireless signaling apparatus;
at least one antenna tuner communicatively coupled to the antenna tuner controller and comprising at least one antenna tuning circuit each communicatively coupled to a respective one of the at least one first radio and to one of the at least one antenna;
at least one processor communicatively coupled to the plurality of radios and the at least one antenna tuner, the at least one processor configured to:
   obtain operational information of each of the at least one first radio, the operational information comprising at least one of packet transfer level, operating channel/frequency band, traffic type, and radio ON/OFF status;
   wake up the antenna tuner controller, and cause an antenna matching instruction to be sent from the antenna tuner controller to the at least one antenna tuner, based on a change in antenna tuning of the wireless signaling apparatus being warranted by a change in the operational information; and
   adjust at least one impedance, provided by the at least one antenna tuner, based on the antenna matching instruction.
Clause 12. The wireless signaling apparatus of clause 11, wherein the at least one processor is configured to:
provide the operational information to the antenna tuner controller; and
determine the antenna matching instruction by the antenna tuner controller based on the operational information.
Clause 13. The wireless signaling apparatus of either of clause 11 or clause 12, wherein the at least one processor is configured to put the antenna tuner controller to sleep based on providing the antenna matching instruction from the antenna tuner controller.
Clause 14. The wireless signaling apparatus of any of clauses 11-13, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.
Clause 15. The wireless signaling apparatus of any of clauses 11-14, wherein to obtain the operational information the at least one processor is configured to intermittently monitor the packet transfer level of each active radio of the at least one first radio.
Clause 16. The wireless signaling apparatus of clause 15, wherein to intermittently monitor the packet transfer level of each active radio of the at least one first radio the at least one processor is configured to periodically monitor the packet transfer level of each active radio of the at least one first radio.
Clause 17. The wireless signaling apparatus of any of clauses 11-14, wherein at least one of a packet transfer level threshold for the at least one processor to determine the change in the operational information, a periodicity for the at least one processor to monitor packet transfer level to obtain the operational information, a threshold time between asynchronous monitoring instances, and a duration for the at least one processor to monitor the packet transfer level depends on an ON/OFF state of a display of the wireless signaling apparatus.
Clause 18. The wireless signaling apparatus of any of clauses 11-17, wherein to obtain the operational information the at least one processor is configured to monitor the packet transfer level of each active radio of the at least one first radio based on a threshold time having passed since a most-recent wake-up of the antenna tuner controller.
Clause 19. The wireless signaling apparatus of any of clauses 11-14, 17, or 18, wherein to obtain the operational information the at least one processor is configured to monitor the packet transfer level of each active radio of the at least one first radio based on occurrence of an asynchronous event trigger.
Clause 20. The wireless signaling apparatus of clause 19, wherein the asynchronous event trigger comprises at least one of: frequency change of at least one of the at least one first radio; change between ON state and OFF/idle state of at least one of the at least one first radio; and traffic type change of at least one of the at least one first radio.
Clause 21. A wireless signaling apparatus comprising:
means for obtaining operational information corresponding to at least one first radio, of a plurality of radios that includes the at least one first radio and a second radio that includes an antenna tuner controller that is configured to be asleep during a low-power mode of the wireless signaling apparatus, the operational information comprising at least one of packet transfer level, operating channel/frequency band, traffic type, and radio ON/OFF status;
means for waking up the antenna tuner controller, and for providing an antenna matching instruction from the antenna tuner controller to at least one antenna tuner of the wireless signaling apparatus, based on a change in antenna tuning of the wireless signaling apparatus being warranted by a change in the operational information; and
means for adjusting at least one impedance, provided by the at least one antenna tuner, based on the antenna matching instruction.
Clause 22. The wireless signaling apparatus of clause 21, further comprising:
means for providing the operational information to the antenna tuner controller; and
means for determining the antenna matching instruction by the antenna tuner controller based on the operational information.
Clause 23. The wireless signaling apparatus of either clause 21 or clause 22, further comprising means for putting the antenna tuner controller to sleep based on providing the antenna matching instruction from the antenna tuner controller.
Clause 24. The wireless signaling apparatus of any of clauses 21-23, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.
Clause 25. The wireless signaling apparatus of any of clauses 21-24, wherein the means for obtaining the operational information comprise means for intermittently monitoring the packet transfer level of each active radio of the at least one first radio.
Clause 26. The wireless signaling apparatus of clause 25, wherein the means for intermittently monitoring comprise means for periodically monitoring.
Clause 27. The wireless signaling apparatus of any of clauses 21-24, wherein at least one of a packet transfer level threshold for determining the change in the operational information, a periodicity of monitoring packet transfer level for obtaining the operational information, a threshold time between asynchronous monitoring instances, and a duration of monitoring the packet transfer level depends on an ON/OFF state of a display of the wireless signaling apparatus.
Clause 28. The wireless signaling apparatus of any of clauses 21-27, wherein the means for obtaining the operational information comprise means for monitoring the packet transfer level of each active radio of the at least one first radio based on a threshold time having passed since a most-recent wake-up of the antenna tuner controller.
Clause 29. The wireless signaling apparatus of any of clauses 21-24, 27, or 28, wherein the means for obtaining the operational information comprise means for monitoring the packet transfer level of each active radio of the at least one first radio based on occurrence of an asynchronous event trigger.
Clause 30. The wireless signaling apparatus of clause 29, wherein the asynchronous event trigger comprises at least one of: frequency change of at least one of the at least one first radio; change between ON state and OFF/idle state of at least one of the at least one first radio; and traffic type change of at least one of the at least one first radio.
Clause 31. A non-transitory, processor-readable storage medium comprising processor-readable instructions to cause at least one processor, to antenna tune a wireless signaling apparatus, to:
obtain operational information corresponding to at least one first radio, of a plurality of radios that includes the at least one first radio and a second radio that includes an antenna tuner controller that is configured to be asleep during a low-power mode of the wireless signaling apparatus, the operational information comprising at least one of packet transfer level, operating channel/frequency band, traffic type, and radio ON/OFF status;
wake up the antenna tuner controller, and provide an antenna matching instruction from the antenna tuner controller to at least one antenna tuner of the wireless signaling apparatus, based on a change in antenna tuning of the wireless signaling apparatus being warranted by a change in the operational information; and
adjust at least one impedance, provided by the at least one antenna tuner, based on the antenna matching instruction.
Clause 32. The non-transitory, processor-readable storage medium of clause 31, further comprising processor-readable instructions to cause the at least one processor to:
provide the operational information to the antenna tuner controller; and
determine the antenna matching instruction by the antenna tuner controller based on the operational information.
Clause 33. The non-transitory, processor-readable storage medium of either clause 31 or clause 32, further comprising processor-readable instructions to cause the at least one processor to put the antenna tuner controller to sleep based on providing the antenna matching instruction from the antenna tuner controller.
Clause 34. The non-transitory, processor-readable storage medium of any of clauses 31-33, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.
Clause 35. The non-transitory, processor-readable storage medium of any of clauses 31-34, wherein the processor-readable instructions to cause the at least one processor to obtain the operational information comprise processor-readable instructions to cause the at least one processor to intermittently monitor the packet transfer level of each active radio of the at least one first radio.
Clause 36. The non-transitory, processor-readable storage medium of clause 35, wherein the processor-readable instructions to cause the at least one processor to intermittently monitor comprise processor-readable instructions to cause the at least one processor to periodically monitor.
Clause 37. The non-transitory, processor-readable storage medium of any of clauses 31-34, wherein at least one of a packet transfer level threshold for determining the change in the operational information, a periodicity of monitoring packet transfer level for obtaining the operational information, a threshold time between asynchronous monitoring instances, and a duration of monitoring the packet transfer level depends on an ON/OFF state of a display of the wireless signaling apparatus.
Clause 38. The non-transitory, processor-readable storage medium of any of clauses 31-38, wherein the processor-readable instructions to cause the at least one processor to obtain the operational information comprise processor-readable instructions to cause the at least one processor to monitor the packet transfer level of each active radio of the at least one first radio based on a threshold time having passed since a most-recent wake-up of the antenna tuner controller.
Clause 39. The non-transitory, processor-readable storage medium of any of clauses 31-34, 37, or 38, wherein the processor-readable instructions to cause the at least one processor to obtain the operational information comprise processor-readable instructions to cause the at least one processor to monitor the packet transfer level of each active radio of the at least one first radio based on occurrence of an asynchronous event trigger.
Clause 40. The non-transitory, processor-readable storage medium of clause 39, wherein the asynchronous event trigger comprises at least one of: frequency change of at least one of the at least one first radio; change between ON state and OFF/idle state of at least one of the at least one first radio; and traffic type change of at least one of the at least one first radio.

### Other Considerations

Other examples and implementations are within the scope of the disclosure and appended claims. For example, features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes one or more of such devices. The phrases “at least one” and “one or more” are used interchangeably and such that “at least one” referred-to object and “one or more” referred-to objects include implementations that have one referred-to object and implementations that have multiple referred-to objects. For example, “at least one device” and “one or more devices” each includes implementations that have one device and implementations that have multiple devices.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices (also called wireless communications devices). A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method of antenna tuning of an apparatus that is in a low-power mode, the method comprising:
obtaining operational information corresponding to at least one first radio, of a plurality of radios that includes the at least one first radio and a second radio that includes an antenna tuner controller that is asleep, the operational information comprising at least one of packet transfer level, operating channel/frequency band, traffic type, and radio ON/OFF status;
waking up the antenna tuner controller, and providing an antenna matching instruction from the antenna tuner controller to at least one antenna tuner of the apparatus, based on a change in antenna tuning of the apparatus being warranted by a change in the operational information; and
adjusting at least one impedance, provided by the at least one antenna tuner, based on the antenna matching instruction.

2. The method of claim 1, further comprising:
providing the operational information to the antenna tuner controller; and
determining the antenna matching instruction by the antenna tuner controller based on the operational information.

3. The method of claim 2, further comprising putting the antenna tuner controller to sleep based on providing the antenna matching instruction from the antenna tuner controller.

4. The method of claim 1, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.

5. The method of claim 1, wherein obtaining the operational information comprises intermittently monitoring the packet transfer level of each active radio of the at least one first radio.

6. The method of claim 5, wherein the intermittently monitoring comprises periodically monitoring.

7. The method of claim 1, wherein at least one of a packet transfer level threshold for determining the change in the operational information, a periodicity of monitoring packet transfer level for obtaining the operational information, a threshold time between asynchronous monitoring instances, and a duration of monitoring the packet transfer level depends on an ON/OFF state of a display of the apparatus.

8. The method of claim 1, wherein obtaining the operational information comprises monitoring the packet transfer level of each active radio of the at least one first radio based on a threshold time having passed since a most-recent wake-up of the antenna tuner controller.

9. The method of claim 1, wherein obtaining the operational information comprises monitoring the packet transfer level of each active radio of the at least one first radio based on occurrence of an asynchronous event trigger.

10. A wireless signaling apparatus comprising:
at least one antenna;
a plurality of radios each corresponding to a respective radio access technology and each communicatively coupled to a respective one of the at least one antenna, the plurality of radios comprising at least one first radio, and a second radio that includes an antenna tuner controller and is configured to be asleep in a low-power mode of the wireless signaling apparatus;
at least one antenna tuner communicatively coupled to the antenna tuner controller and comprising at least one antenna tuning circuit each communicatively coupled to a respective one of the at least one first radio and to one of the at least one antenna;
at least one processor communicatively coupled to the plurality of radios and the at least one antenna tuner, the at least one processor configured to:
obtain operational information of each of the at least one first radio, the operational information comprising at least one of packet transfer level, operating channel/frequency band, traffic type, and radio ON/OFF status;
wake up the antenna tuner controller, and cause an antenna matching instruction to be sent from the antenna tuner controller to the at least one antenna tuner, based on a change in antenna tuning of the wireless signaling apparatus being warranted by a change in the operational information; and
adjust at least one impedance, provided by the at least one antenna tuner, based on the antenna matching instruction.

11. The wireless signaling apparatus of claim 10, wherein the at least one processor is configured to:
provide the operational information to the antenna tuner controller; and
determine the antenna matching instruction by the antenna tuner controller based on the operational information.

12. The wireless signaling apparatus of claim 11, wherein the at least one processor is configured to put the antenna tuner controller to sleep based on providing the antenna matching instruction from the antenna tuner controller.

13. The wireless signaling apparatus of claim 10, wherein the change in the operational information comprises a change in packet transfer level between a high activity state and a low activity state that comprises the packet transfer level one of increasing above a first activity threshold to change from the low activity state to the high activity state, or decreasing below a second activity threshold, below the first activity threshold, to change from the high activity state to the low activity state.

14. The wireless signaling apparatus of claim 10, wherein to obtain the operational information the at least one processor is configured to intermittently monitor the packet transfer level of each active radio of the at least one first radio.

15. The wireless signaling apparatus of claim 14, wherein to intermittently monitor the packet transfer level of each active radio of the at least one first radio the at least one processor is configured to periodically monitor the packet transfer level of each active radio of the at least one first radio.

16. The wireless signaling apparatus of claim 10, wherein at least one of a packet transfer level threshold for the at least one processor to determine the change in the operational information, a periodicity for the at least one processor to monitor packet transfer level to obtain the operational information, a threshold time between asynchronous monitoring instances, and a duration for the at least one processor to monitor the packet transfer level depends on an ON/OFF state of a display of the wireless signaling apparatus.

17. The wireless signaling apparatus of claim 10, wherein to obtain the operational information the at least one processor is configured to monitor the packet transfer level of each active radio of the at least one first radio based on a threshold time having passed since a most-recent wake-up of the antenna tuner controller.

18. The wireless signaling apparatus of claim 10, wherein to obtain the operational information the at least one processor is configured to monitor the packet transfer level of each active radio of the at least one first radio based on occurrence of an asynchronous event trigger.

19. The wireless signaling apparatus of claim 18, wherein the asynchronous event trigger comprises at least one of: frequency change of at least one of the at least one first radio; change between ON state and OFF/idle state of at least one of the at least one first radio; and traffic type change of at least one of the at least one first radio.

20. A wireless signaling apparatus comprising:
means for obtaining operational information corresponding to at least one first radio, of a plurality of radios that includes the at least one first radio and a second radio that includes an antenna tuner controller that is configured to be asleep during a low-power mode of the wireless signaling apparatus, the operational information comprising at least one of packet transfer level, operating channel/frequency band, traffic type, and radio ON/OFF status;
means for waking up the antenna tuner controller, and for providing an antenna matching instruction from the antenna tuner controller to at least one antenna tuner of the wireless signaling apparatus, based on a change in antenna tuning of the wireless signaling apparatus being warranted by a change in the operational information; and
means for adjusting at least one impedance, provided by the at least one antenna tuner, based on the antenna matching instruction.
